(19) United States
(12) Patent Application Publication
(10) Pub. No.: US 2017/0280704 A1
(43) Pub. Date: Oct. 5, 2017

(54) GAME CALL WITH ENCLOSURE FOR DIAPHRAGM REED

(71) Applicant: Primos, Inc., Flora, MS (US)

(72) Inventor: Anthony A. Foster, Brookhaven, MS (US)

(73) Assignee: Primos, Inc., Flora, MS (US)

(21) Appl. No.: 15/087,890

(22) Filed: Mar. 31, 2016

(51) Int. Cl. A01M 31/00

(52) U.S. Cl. CPC A01M 31/004

(57) ABSTRACT

An adjustable tone game call apparatus has a housing with an internal air passage through which air may be blown. A reed is positioned in the housing along the passage and is configured to vibrate and generate sound upon passage of air through the air passage. An adjustment member on the housing rotates or translates to vary pressure applied to the reed, thereby adjusting the tone or pitch produced by the reed due to the pressure changing the effective length of a diaphragm of the reed. Thus, by using the adjustable tone game call, a hunter may produce a variety of pitches and tones to mimic various types of game animals and predators.

### TECHNICAL FIELD

The present disclosure generally relates to the field of game call devices for imitating animal sounds. More particularly, the disclosure pertains to diaphragm-type calls used commonly for turkeys and other game animals.

### BACKGROUND

Diaphragm-type turkey calls have been in use for many years. A hunter causes the call to emit sounds by placing the call into his mouth and causing air to move across a diaphragm to create sounds. The airflow caused the diaphragm to vibrate to make sounds that could not be produced by the hunter alone. Skilled hunters use the call to mimic a variety of realistic animal sounds.

Typically, these calls comprise a pair of generally rectangular or horseshoe-shaped frame elements supporting one or more strips of pre-tensioned diaphragm material such as latex, rubber, or the like. The diaphragm is held by the frame along its edges and at the rear, and is free to vibrate and produce sound at its outward end. The frame and diaphragm elements are surrounded by a tab or tape of paper or cloth which allows the call to be placed against and seal on the roof of the user's mouth.

Typically, a hunter will want to be able to make a number of different calls, so as to be able to attract the maximum number of birds or other game animals such as elk. Different diaphragms are used to produce different pitches and tones based on their shape and composition. For example, some diaphragms have contouring or tapering or slits in the diaphragm, and some have differing offsets, tensions and materials. This selection of devices permits the hunter to variously produce clear or raspy calls, light or loud calls, or calls of varying pitch. The disadvantage is that the hunter has to carry many devices to produce the variety of calls.

Some hunters may have problems using in-mouth diaphragm calls. Missing teeth, palate shape variation, and other mouth, cheek, and lip conditions may render in-mouth calls unusable due to the hunter being unable to properly control airflow over the diaphragm. Additionally, diaphragm calls can be difficult and time-consuming to learn to use. Accordingly, there is a need for improvements to diaphragm based game calls.

### SUMMARY

One aspect of the present disclosure relates to an adjustable tone game call apparatus. The apparatus may comprise a housing having an internal air passage, with the internal air passage having an entrance opening and an exit opening. A reed may be positioned in the internal air passage between the entrance opening and the exit opening, with the reed comprising a frame and a diaphragm. The diaphragm may have an effective length, wherein passage of air through the internal air passage may induce vibration of the diaphragm across the effective length. An adjustment member may be rotatably engaged with the housing, with the adjustment member being configured to adjust pressure against the frame according to a rotated position of the adjustment member relative to the housing. The adjustment of pressure against the frame may adjust the effective length of the diaphragm.

In some embodiments, a spacer may be positioned between the reed and the adjustment member, with the spacer transferring pressure to the frame of the reed upon rotation of the adjustment member. The spacer may comprise at least one protrusion configured to retain the position of the reed within the housing. The effective length may extend laterally across an edge of the diaphragm relative to a longitudinal axis of the internal air passage. The adjustment member may comprise a first threaded surface, and the housing may comprise a second threaded surface, with the first and second threaded surfaces engaging each other. The frame of the reed may comprise a U-shape or semicircular shape positioned around the diaphragm. The apparatus may further comprise an insert positioned between the housing and the reed, with the insert at least partially defining a portion of the internal air passage. An insert may have an external portion accessible from an exterior of the housing and an internal portion positioned adjacent to the diaphragm, with the insert being movable relative to the housing and the diaphragm. The insert may comprise a resilient material.

In another aspect of the disclosure, a method for producing sound with an adjustable tone game call apparatus is set forth. The method may comprise providing an adjustable tone game call apparatus which comprises a housing having an air inlet and an air outlet. The air inlet and outlet may be connected by a passage through the housing. A reed may be positioned in the passage, and an adjustable member may be configured to rotate relative to the housing. The method may further comprise inducing airflow through the passage to produce a first tone via vibration of the reed, rotating the adjustable member relative to the housing, wherein rotation of the adjustable member changes pressure applied to the reed, and inducing airflow through the passage to produce a second tone via vibration of the reed, with the second tone having a higher or lower pitch relative to the first tone.

The method may further comprise providing a spacer positioned between the adjustable member and the reed, with the spacer transferring pressure to the reed from the adjustable member. The method may also include providing an insert positioned adjacent to the reed and applying a force to the insert to vary the first or second tone produced by vibration of the reed. Inducing airflow through the passage may comprise blowing air into the passage. Rotating the adjustable member relative to the housing may also cause the adjustable member to translate relative to the housing. The first tone may correspond with a first effective length measured across the reed and the second tone may correspond with a second effective length measured across the reed.

Yet another aspect of the disclosure relates to a game call apparatus that comprises a housing having an internal air passage, with the internal air passage having an entrance opening and an exit opening, and a reed positioned in the internal air passage between the entrance opening and the exit opening, with the reed comprising a frame and a diaphragm and the diaphragm having an effective length. Passage of air through the internal air passage may induce vibration of the diaphragm across the effective length. The apparatus may also include an adjustment member engaged with the housing and translatable relative to the housing, with the adjustment member being configured to adjust pressure against the frame according to a translated position of the adjustment member relative to the housing. The pressure against the frame may adjust the effective length of the diaphragm.

The adjustment member may also be rotatable relative to the housing. The adjustment member may comprise a dial. The adjustment member and housing may comprise at least one relative position indicator, and the at least one relative position indicator may comprise a plurality of position indicators positioned around a circumference of the adjustment member.

The above summary of the present invention is not intended to describe each embodiment or every implementation of the present invention. The Figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIGS. 1A and 1B show perspective views of a game call apparatus of the present disclosure.

FIGS. 2A and 2B show exploded perspective views of the game call apparatus of FIGS. 1A-1B.

FIGS. 3A and 3B show top and bottom views, respectively, of an insert of the game call apparatus of FIGS. 1A-1B.

FIG. 4 shows a perspective view of the housing of the game call apparatus of FIGS. 1A-1B.

FIG. 5 shows a side section view taken centrally through the game call apparatus of FIGS. 1A-1B along section lines 5-5 in FIG. 6.

FIG. 6 shows an end section view taken through the game call apparatus of FIGS. 1A-1B along section lines 6-6 in FIG. 5.

FIG. 7 shows a side section view taken through the game call apparatus of FIGS. 1A-1B along section lines 7-7 in FIG. 6.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure generally relates to an adjustable tone game call apparatus that may be used with a diaphragm reed to imitate animal sounds with various tonal and pitch properties. The reed may be positioned in a housing enclosure having an internal air passage through which the hunter blows air to cause vibration of the diaphragm of the reed. An adjustment member, such as a dial or screw, may be engaged with the housing and configured to adjust pressure against the frame of the reed based on the relative positions of the adjustment member and the housing. The pressure against the frame of the reed may adjust an effective length of the diaphragm, thereby adjusting the pitch or tone it produces when air flows over the diaphragm. The sound produced by the diaphragm may be varied by controlling the position of the adjustment member to replicate sounds of, for example, birds such as turkeys, big game animals such as elk, wounded animals such as rabbits to attract predators such as coyotes, and many other animal sounds.

A spacer may be positioned between the adjustment member and the reed. The spacer may be in contact with the adjustment member and may translate within the housing as the adjustment member is rotated relative to the housing. The spacer may be used to distribute pressure across the frame of the reed as the adjustment member is moved. The spacer may also comprise protrusions used to hold the position of the reed in the housing and/or to prevent tampering with the diaphragm when the game call is assembled. The spacer may be referred to as a washer.

An insert may also be included in the game call. The insert may comprise a flexible or resilient material and may be positioned adjacent to the diaphragm. The air passage through the game call may pass over or through the insert and the insert may direct air toward the diaphragm to cause the diaphragm to oscillate. The insert may also dampen vibration and oscillation of the housing of the apparatus. The insert may also comprise a button or other external portion that can be accessed from the outside of the housing. Manipulating the button may cause the insert to contact and manipulate the diaphragm or alter the flow of air toward or across the diaphragm. Thus, the insert may also be used to adjust and control the sound produced by the game call.

Methods and processes of making and using an adjustable tone game call are also disclosed. An example method may include providing the adjustable tone game call apparatus, inducing airflow through a passage in the game call to produce a first tone or sound by vibration of a reed in the apparatus, rotating an adjustable member or moving an insert or button of the apparatus to change pressure applied to the reed or diaphragm, and inducing airflow over the reed to produce a second tone or sound. Changing the pressure applied to the reed or diaphragm may comprise changing a clamping force applied to the reed or diaphragm.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

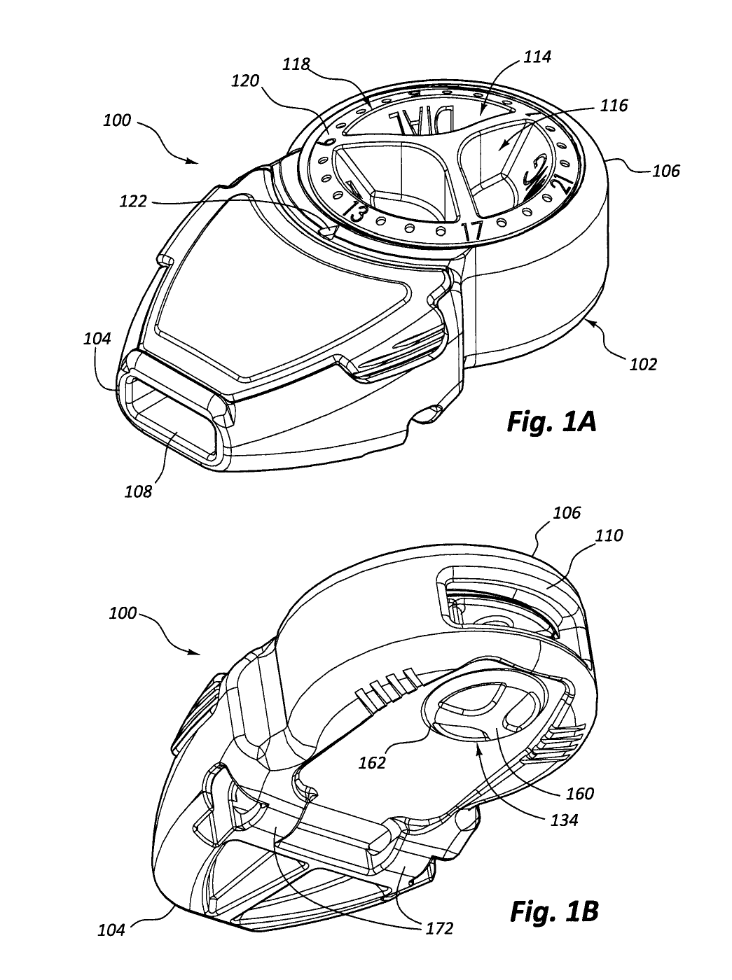

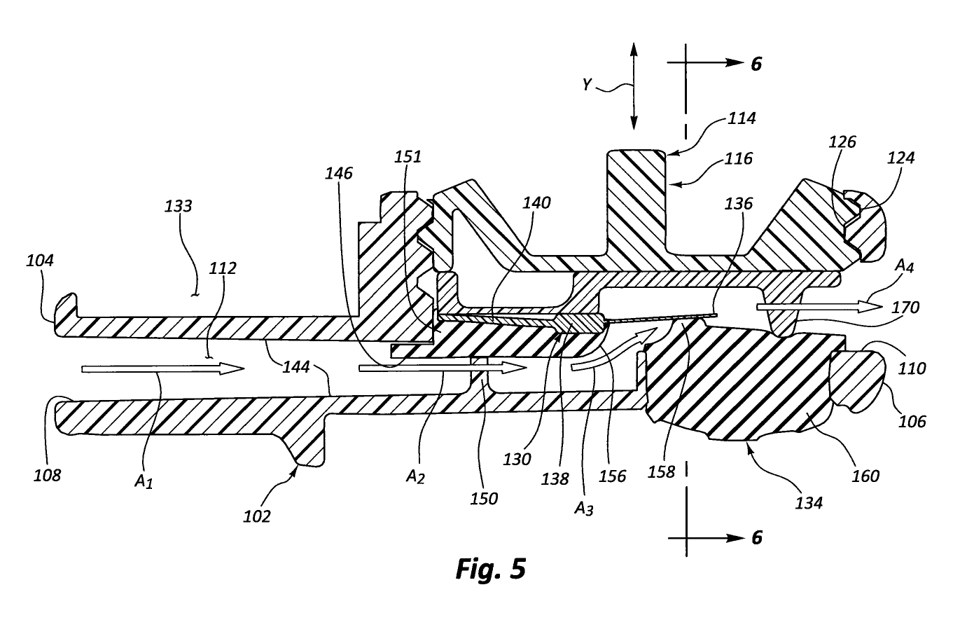

Turning now to the figures in detail, FIGS. 1A-1B show external perspective views of an example game call apparatus 100 according to the present disclosure. The apparatus may comprise a housing 102 having a first end 104 and a second end 106. The first end 104 may comprise an inlet opening 108 (see FIG. 1A) and the second end 106 may comprise an outlet opening 110 (see FIG. 1B). An interior passage 112 (see FIG. 5) may extend through the housing 102 and link the inlet and outlet openings 108, 110.

A dial 114 may be positioned in the housing 102. The dial 114 may alternatively be referred to as a screw or an adjustment member. The dial 114 may comprise a handle portion 116 positioned centrally within the dial 114 and a circumferential portion 118 comprising a plurality of indicators (e.g., 120). The plurality of indicators may comprise symbols (e.g., dots, hash marks, animal profiles, or arrows), letters, numerals, or other markers. In some embodiments, the plurality of indicators may be comparative indicators, such as numbers that have decreasing values (relative to a marker 122 on the housing 102) as the dial 114 is turned in one direction (e.g., counterclockwise) and that have increasing values in the other direction (e.g., clockwise). Comparative indicators may indicate differences between different positions of the dial 114 relative to the housing 102. The dial 114 may be rotatable relative to the housing 102 to vary the position of the plurality of indicators relative to the housing 102.

The marker 122 may be an arrow or other indicator that may be used as a reference point on the housing 102 for comparison with the plurality of indicators 120 of the dial 114. Alternatively, the dial 114 may comprise a marker (e.g., an arrow) and the housing 102 may comprise a plurality of circumferentially-positioned indicators around the dial 114 that may be used to compare the relative rotated positions of the dial 114 and the housing 102.

The plurality of indicators may correspond with different tones produced by the call apparatus 100. Thus, rotation of the dial 114 may correspond with adjustment of a pitch or tone produced by the call apparatus 100. Specific rotated positions of the dial 114 may correspond with specific pitches or tones produced by the call apparatus 100.

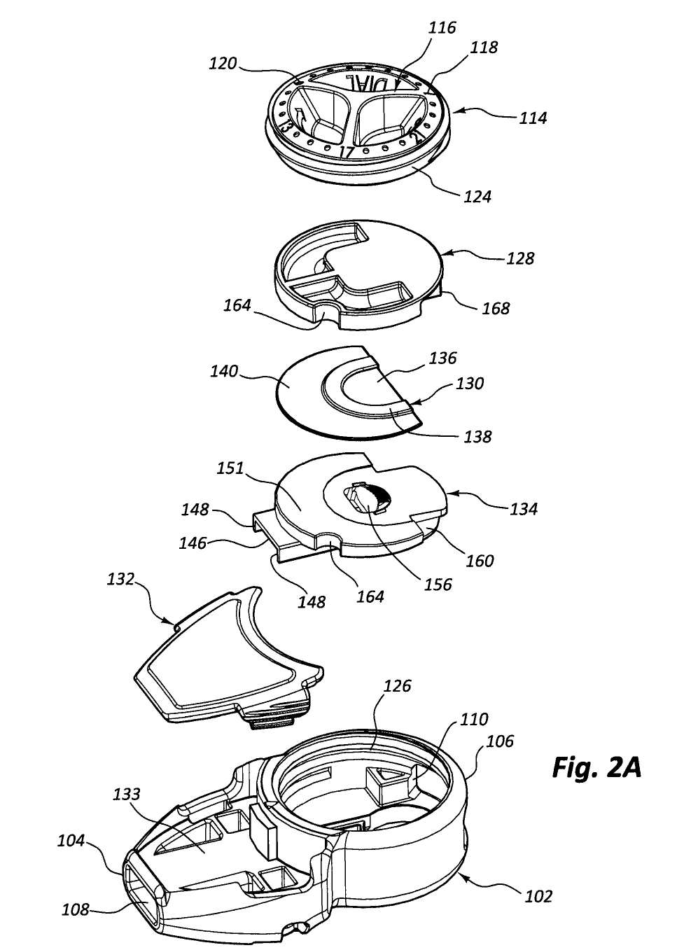

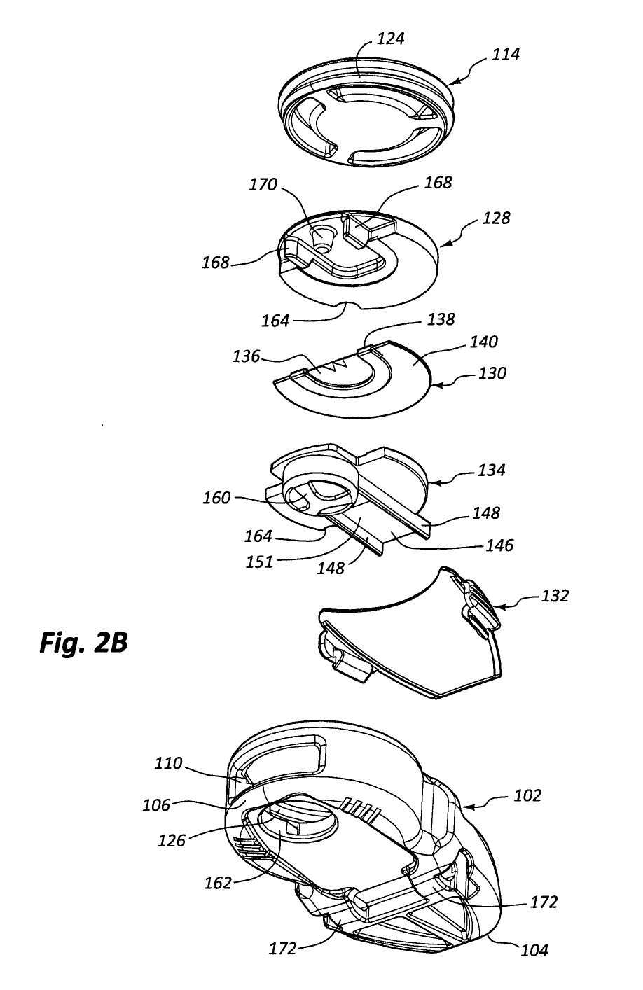

A method of effecting tone adjustment may be explained with reference to FIGS. 2A-2B and 5. The dial 114 may have a threaded outer surface 124 extending around the external perimeter of the dial 114 and its lateral surface, and the housing 102 may comprise a threaded inner surface 126 extending around an aperture in which the perimeter of the dial 114 is engaged and threaded. Thus, the threaded outer and inner surfaces 124, 126 may be threadedly engaged to each other, as shown in FIGS. 1A-1B and 5-6. As the dial 114 rotates relative to the housing 102 around the vertical axis Y, the threads may cause the dial 114 to translate along the vertical axis Y relative to the housing 102. See FIG. 5.

As shown in FIGS. 2A-2B and 5-6, the housing 102 may connect to or contain a spacer 128, a reed 130, a door 132, and an insert 134. The spacer 128 may be positioned within the housing 102 in contact with the dial 114 and the reed 130. The reed 130 may be positioned in contact with and between the spacer 128 and the insert 134. The insert 134 may contact the reed 130 and the housing 102. Thus, the reed 130 may be clamped in the housing 102 due to pressure applied to the top and bottom of the reed 130 by the spacer 128 and the insert 134. This pressure may be referred to as a clamping pressure or clamping force on the reed 130. The insert 134 may comprise a flexible and resilient material such as, for example, a silicone rubber that is compressible and bendable by hand.

The door 132 may be positioned on the housing 102 to cover and protect an inner chamber 133. See FIGS. 2A and 5. The inner chamber 133 may be a storage chamber for extra reeds 130 or other small and thin items. The door 132 may snap on and off the housing 102 to provide a removable cover for the inner chamber 133.

In some embodiments, the reed 130 may be a conventional mouth diaphragm reed that is commonly used as a call for turkeys and other game animals. The reed 130 may comprise a diaphragm 136, a frame 138, and a flange 140 (i.e., tape or tab). The diaphragm 136 may comprise a highly flexible material such as, for example, latex, nitrile, rubber, or a similar material. The diaphragm 136 may be stretched flat and straight or may be stretched with a non-linear edge shape. The frame 138 may comprise a relatively rigid material such as, for example, aluminum or zinc metal. The diaphragm 136 may be positioned within the frame 138 and may be stretched or taut across the frame 138. The frame 138 may form a U-shape or curved semicircular crescent shape around the diaphragm 136. In some embodiments, the frame 138 may clamp the diaphragm 136 around the edges of the diaphragm 136 such that the frame 138 applies pressure against the top and bottom of the diaphragm 136 and keeps the diaphragm 136 stretched in place. As the top and bottom of the frame 138 are compressed, the frame 138 may narrow the width across the diaphragm 136 that is able to oscillate, and as pressure on the frame 138 is reduced, the effective length across the diaphragm 136 may increase. The flange 140 may protect the frame 138 and may help hold the reed 130 together.

FIG. 5 shows a side section view centrally through the call apparatus 100. This view illustrates airflow paths through the apparatus 100 that may cause the reed 130 to sound. A first portion A₁ of the airflow enters the call apparatus 100 via the inlet opening 108. For example, the hunter may blow air into the inlet opening 108 using his mouth. The first portion A₁ is bounded in all transverse directions by an interior surface 144 of the housing 102 that forms a bore through the housing 102. The air then flows to a second portion A₂ of the flow path.

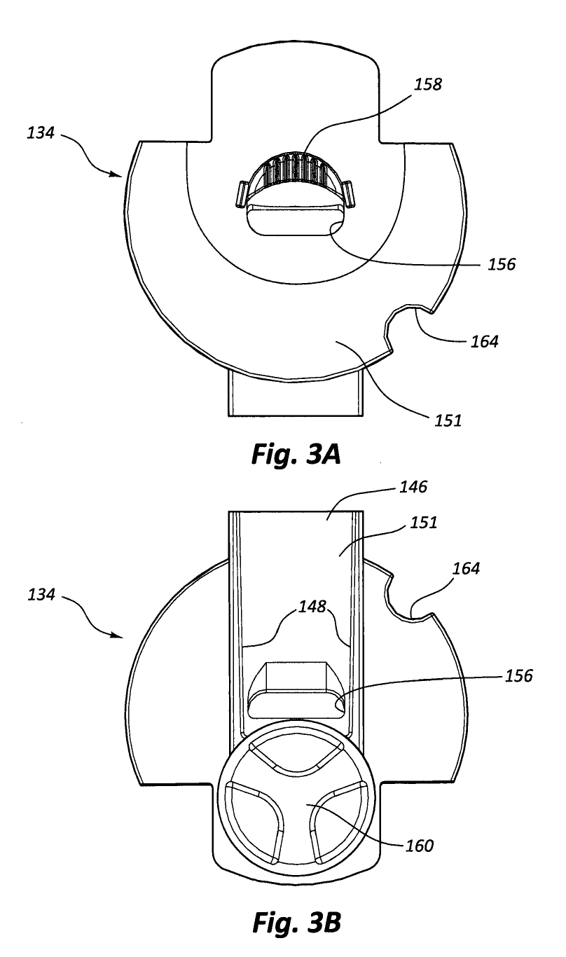

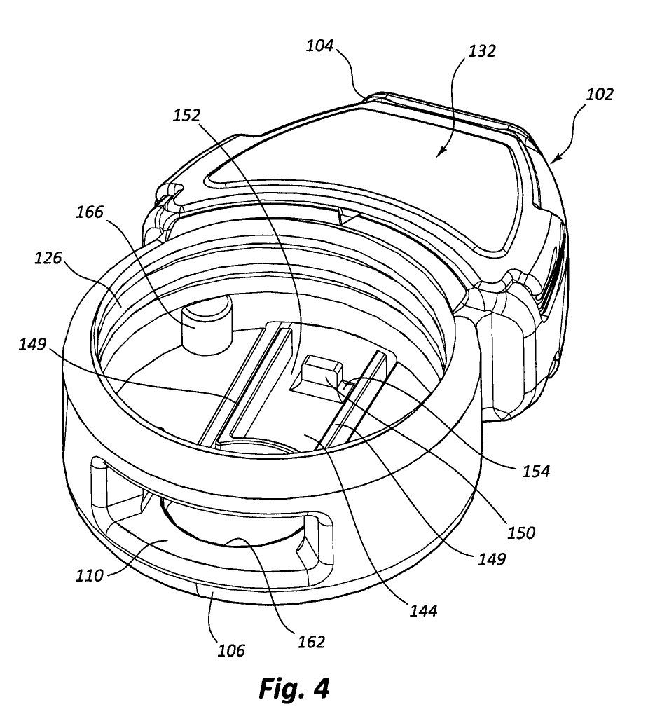

The second portion A₂ of the flow path extends through the housing 102 as well, but is bounded on the upper surface 146 by the insert 134. See FIGS. 3A-3B and 5. Lateral sides 148 of the insert 134 may be positioned laterally adjacent to the second portion A₂ but may be separated from the second portion A₂ by inner walls 149 in the housing 102. See FIG. 4. The bottom surface of the second portion A₂ is part of interior surface 144 of the housing 102. See FIGS. 4 and 5. The passage through which the second portion A₂ of the flow path extends is narrower than the first portion A₁. The air in the second portion A₂ may therefore flow at a higher speed than the first portion A₁. The insert 134 may also comprise a more flexible material than the housing 102, so vibration and sound induced by the movement of air through the second portion A₂ may be more dampened than movement of air through the first portion A₁.

The upper surface 146 is part of an upper wall 151 of the insert 134 that is configured to contact the reed 130. The resilient material used to construct the upper wall 151 may also dampen vibration of the frame 138 and flange 140 of the reed 130 so that vibration of the diaphragm 136 makes a clearer, more natural sound that has similar dampening to a human mouth.

A support bar 150 extends from the interior surface 144 of the housing 102, as shown in FIGS. 4-5. The support bar 150 appears to block airflow in FIG. 5, but FIG. 4 illustrates that air may flow around the support bar 150 in side passages 152, 154 that are part of second portion A₂. Thus, the second portion A₂ of the flow path flows around the support bar 150 and internal to the inner walls 149. The support bar 150 may hold the upper surface 146 of the insert 134 in place as the call apparatus 100 is used and stored. This bar 150 may prevent the flexible upper surface 146 from collapsing downward and obstructing or overly narrowing the second portion A₂ of the flow path.

A third portion A₃ of the flow path extends from the second portion A₂ and turns upward into the underside of the diaphragm 136. In doing so, the third portion A3 extends through an aperture 156 in the insert 134. See FIGS. 3A-3B and 5. The aperture 156 may be shaped and contoured to direct air across the diaphragm 136 toward the outlet opening 110 of the housing 102.

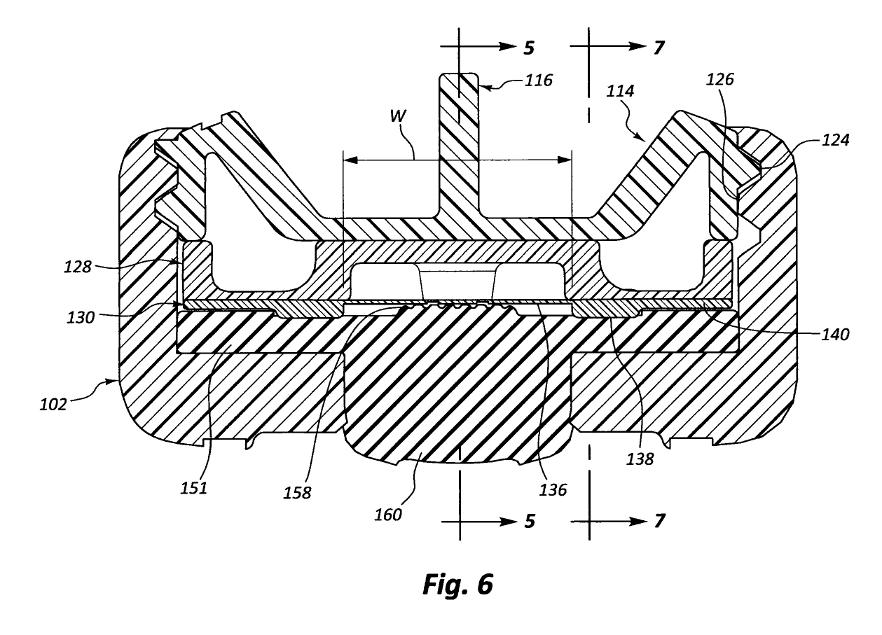

The insert 134 may have a diaphragm contact portion 158 adjacent to the aperture 156 on the upper side of the insert 134 near the diaphragm 136. See FIGS. 2A, 3A, and 5-6. The contact portion 158 may comprise a texture such as, for example, a plurality of adjacent and alternating grooves and ridges (see FIG. 6), that alters the flow of air past the diaphragm 136 and/or may alter the vibration of the diaphragm 136 when the texture is pushed against the diaphragm 136. The contact portion 158 may be at least partially positioned opposite a button portion 160 of the insert 134. The third portion A₃ of the flow path may extend between the diaphragm 136 and the contact portion 158.

Finally, a fourth portion A₄ of the flow path may extend from the diaphragm 136 out of the outlet opening 110 of the housing 102. The outlet opening 110 may have an inner surface having a horn, cone, or otherwise expanding shape to amplify sounds coming from the diaphragm 136 through the fourth portion A₄.

The button portion 160 of the insert 134 may comprise a flexible material such as the material used in the rest of the insert 134. The button portion 160 may extend through a bottom aperture 162 of the housing 102. See FIGS. 2B and 4. The button portion 160 may therefore be accessible by the hunter's fingers from the exterior of the housing 102. As the hunter blows into the inlet opening 108 and air passes through the airflow passage, the hunter may press inward on the button portion 160 to drive the diaphragm contact portion 158 into contact with the diaphragm 136. The interaction between the contact portion 158 and the diaphragm 136 may alter the sound of the diaphragm 136 to make “clicks,” “yelps,” “whoops,” and other sounds that mimic and resemble sounds made by game animals or predators.

As a user turns the handle 116 and the dial 114 translates along the vertical axis Y relative to the housing 102, the pressure applied by the dial 114 to the spacer 128 may change. Thus, the spacer 128 may vary the pressure it applies to the reed 130. The spacer 128 may distribute the pressure across the frame 138 of the reed 130 and thereby avoid stress concentrations that could distort the diaphragm 136. Additionally, the spacer 128 does not rotate as the dial 114 rotates, so the dial 114 does not torque the reed 130 and potentially rotationally distort the diaphragm 136.

The spacer 128 and insert 134 (and, in some embodiments, the reed 130) may each comprise a notch 164. The notch 164 on these elements may align with a rail 166 within the housing 102 (see FIG. 4) that guides the movement of the spacer 128 and insert 134 as they translate relative to the housing 102 so that any torque applied to them by the dial 114 does not cause them to rotate within the housing 102. Thus, the spacer 128 may translate within the housing 102 with the notch 164 on the rail 166.

The pressure against the frame 138 may compress the diaphragm 136 between portions of the frame 138 and thereby adjust the effective length of the diaphragm 136, i.e., the width across the diaphragm that is capable of vibration. FIG. 6 shows an example effective length W across the diaphragm 136. The effective length W may extend laterally across the edge of the diaphragm 136 perpendicular to a longitudinal axis of the housing 102 (e.g., an axis that extends along fourth portion A₄. The effective length W may decrease as pressure against the frame 138 increases, and the width W may increase as pressure against the frame 138 decreases. Accordingly, the width of the diaphragm 136 that is capable of oscillating may change, and the pitch and tone produced by the vibration of the diaphragm may change. The rotated position of the dial 114 may therefore adjust the pitch and tone of the call apparatus 100. When used in conjunction with the tone control provided by manipulation of the button portion 160, the call apparatus 100 may be used to create a large variety of pitches and tones that are used by hunters.

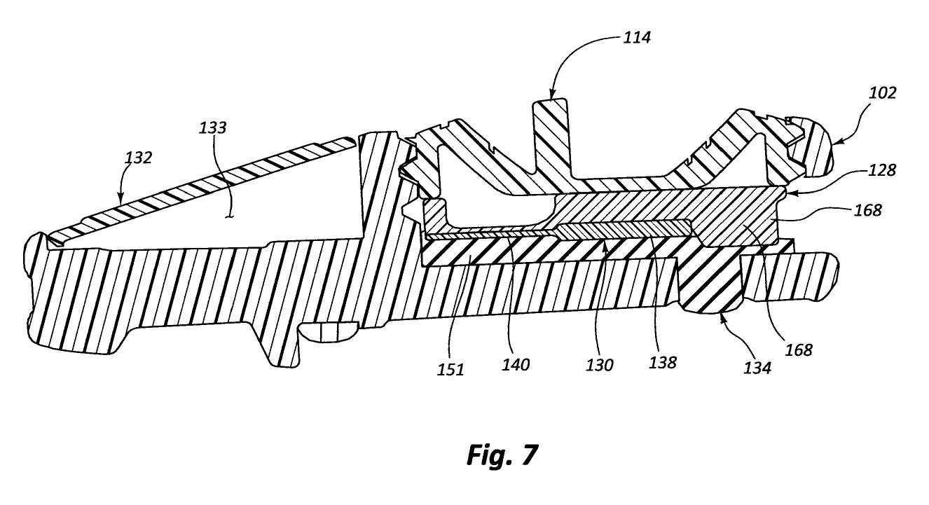

The spacer 128 may also comprise at least one retainer post 168 configured to contact the reed 130. See FIGS. 1B, 2B, and 7. The retainer post 168 may be referred to as a protrusion. The retainer posts 168 shown in the figures may provide an outer or distal boundary for the reed 130 within the housing 102 that prevents the reed 130 from moving out of the outlet opening 110 at the second end 106 of the housing 102. The retainer posts 168 may also keep the reed 130 from moving within the housing 102 by contacting the outer end of the frame 138. Thus, the reed 130 may maintain a particular orientation relative to the spacer 128 at all times. This may be used to help

The underside of the spacer 128 may also have a central post 170. See FIGS. 2B and 5. The central post 170 may prevent large debris from being lodged in the outlet opening 110 and may prevent tampering with the diaphragm 136 within the housing. The central post 170 may also contact the insert 134 and may thereby prevent the insert 134 from being pushed into the housing 102 too far or in a manner that would cause the button portion 160 to fall out of alignment with the bottom aperture 162 of the housing 102.

The underside of the housing 102 may comprise a plurality of loops 172 configured to receive a cord or lanyard. Thus, the call apparatus 100 may be worn around the hunter's neck on the cord or lanyard.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including” and “having” come as used in the specification and claims shall have the same meaning as the term “comprising.”

What is claimed is:

1. An adjustable tone game call apparatus, comprising:
a housing having an internal air passage, the internal air passage having an entrance opening and an exit opening;
a reed positioned in the internal air passage between the entrance opening and the exit opening, the reed comprising a frame and a diaphragm, the diaphragm having an effective length, wherein passage of air through the internal air passage induces vibration of the diaphragm across the effective length;
an adjustment member rotatably engaged with the housing, the adjustment member being configured to adjust pressure against the frame according to a rotated position of the adjustment member relative to the housing, wherein the adjustment of pressure against the frame adjusts the effective length of the diaphragm.

2. The adjustable tone game call apparatus of claim 1, further comprising a spacer positioned between the reed and the adjustment member, the spacer transferring pressure to the frame of the reed upon rotation of the adjustment member.

3. The adjustable tone game call apparatus of claim 2, wherein the spacer comprises at least one protrusion configured to retain the position of the reed within the housing.

4. The adjustable tone game call apparatus of claim 1, wherein the effective length extends laterally across an edge of the diaphragm relative to a longitudinal axis of the internal air passage.

5. The adjustable tone game call apparatus of claim 1, wherein the adjustment member comprises a first threaded surface and the housing comprises a second threaded surface, the first and second threaded surfaces engaging each other.

6. The adjustable tone game call apparatus of claim 1, wherein the frame of the reed comprises a U-shape or semicircular shape positioned around the diaphragm.

7. The adjustable tone game call apparatus of claim 1, further comprising an insert positioned between the housing and the reed, the insert at least partially defining a portion of the internal air passage.

8. The adjustable tone game call apparatus of claim 1, further comprising an insert having an external portion accessible from an exterior of the housing and an internal portion positioned adjacent to the diaphragm, the insert being movable relative to the housing and the diaphragm.

9. The adjustable tone game call apparatus of claim 8, wherein the insert comprises a resilient material.

10. A method for producing sound with an adjustable tone game call apparatus, the method comprising:
providing an adjustable tone game call apparatus, comprising:
a housing having an air inlet and an air outlet, the air inlet and outlet connected by a passage through the housing;
a reed positioned in the passage;
an adjustable member configured to rotate relative to the housing;
inducing airflow through the passage to produce a first tone via vibration of the reed;
rotating the adjustable member relative to the housing, wherein rotation of the adjustable member changes pressure applied to the reed;
inducing airflow through the passage to produce a second tone via vibration of the reed, the second tone having a higher or lower pitch relative to the first tone.

11. The method of claim 10, further comprising providing a spacer positioned between the adjustable member and the reed, the spacer transferring pressure to the reed from the adjustable member.

12. The method of claim 10, further comprising providing an insert positioned adjacent to the reed, and applying a force to the insert to vary the first or second tone produced by vibration of the reed.

13. The method of claim 10, wherein inducing airflow through the passage comprises blowing air into the passage.

14. The method of claim 10, wherein rotating the adjustable member relative to the housing also causes the adjustable member to translate relative to the housing.

15. The method of claim 10, wherein the first tone corresponds with a first oscillation width measured across the reed and the second tone corresponds with a second effective length measured across the reed.

16. A game call apparatus, comprising:
a housing having an internal air passage, the internal air passage having an entrance opening and an exit opening;
a reed positioned in the internal air passage between the entrance opening and the exit opening, the reed comprising a frame and a diaphragm, the diaphragm having an effective length, wherein passage of air through the internal air passage induces vibration of the diaphragm across the effective length;
an adjustment member engaged with the housing and translatable relative to the housing, the adjustment member being configured to adjust pressure against the frame according to a translated position of the adjustment member relative to the housing, wherein the pressure against the frame adjusts the effective length of the diaphragm.

17. The game call apparatus of claim 16, wherein the adjustment member is rotatable relative to the housing.

18. The game call apparatus of claim 17, wherein the adjustment member comprises a dial.

19. The game call apparatus of claim 16, wherein the adjustment member and housing comprise at least one relative position indicator.

20. The game call apparatus of claim 19, wherein the at least one relative position indicator comprises a plurality of position indicators positioned around a circumference of the adjustment member.
